(19) United States
(12) Patent Application Publication
(10) Pub. No.: US 2005/0210596 A1
(43) Pub. Date: Sep. 29, 2005

(54) Use of polyelectrolytes in the production of leather

(75) Inventors: Stephan Huffer, Ludwigshafen (DE); Gunther Pabst, Mannheim (DE); Tilman Ludecke Taeger, Seeheim-Jugenheim (DE); Stefan Schroeder, Neuleiningen (DE); Philippe Lamalle, Lambsheim (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/505,448

(22) PCT Filed: Mar. 12, 2003
(86) PCT No.: PCT/EP03/02504

§ 371 Date: Sep. 1, 2004

(30) Foreign Application Priority Data
Mar. 15, 2002 (DE) 102 11 670.9
Apr. 3, 2002 (DE) 102 14 776.0

(51) Int. Cl. C14C 1/00

(52) U.S. Cl. 8/94.15

(57) ABSTRACT

A process for the production of semifinished products and intermediates in the production of leather using one or more organic polyelectrolytes comprises at least one of the following steps: (a) Addition of one or more polyelectrolytes and from 0 to 0.7% by weight, based on the salted weight, of lime immediately before or during liming, (b) addition of one or more polyelectrolytes before or during deliming, (c) addition of one or more polyelectrolytes before or during bating, (d) addition of one or more polyelectrolytes and a total of from 0 to 3% by weight, based on the pelt weight, of alkali metal or alkaline earth metal salt immediately before or in the pickle.

The present invention relates to the use of one or more organic polyelectrolytes for the production of leather or skins. The present invention relates in particular to a process for the production of semifinished products and intermediates in the production of leather using one or more organic polyelectrolytes, comprising at least one of the following steps:
(a) Addition of one or more polyelectrolytes and from 0 to 0.7% by weight, based on the salted weight, of lime immediately before or during the liming,
(b) addition of one or more polyelectrolytes before or during the deliming,
(c) addition of one or more polyelectrolytes before or during the bating,
(d) addition of one or more polyelectrolytes and a total of from 0 to 3% by weight, based on the pelt weight, of alkali metal or alkaline earth metal salt immediately before or in the pickle.

During leather production, the hide passes at least once through the pH range from strongly alkaline to acidic. During this, collagen, which is a substantial component of the animal hides, is converted anionically, neutrally or zwitterionically and cationically into various charge states. Particularly at acidic pH, plumping, also referred to as acid plumping, is observed. The plumping causes generally irreversible damage to the hide to be tanned, in particular extremely loose grain and greatly reduced tensile strength, cf. also F. Stather, Gerbereichemie und Gerbereitechnologie, Akademie Verlag Berlin, 3rd edition, page 84, 1957.

In order to avoid plumping, tanneries usually add considerable amounts of sodium chloride to the pickle liquors or the formulations in the pickle, in general from 4 to 7% by weight, based on the pelt weight. This results in a considerable salt load in the wastewater.

Attempts have already been made to use nonplumping acids based on naphthalenesulfonic acids or naphtholsulfonic acids and the corresponding alkali metal salts (cf. for example E. Heidemann, Fundamentals of Leather Manufacturing, Roether-Verlag Darmstadt, pages 197-9, 1993). It is observed that, although the salt load can be reduced by the use of nonplumping acids, at the same time the COD of the wastewater is significantly increased. Also because of the poor biodegradability of the abovementioned nonplumping acids, the environmental friendliness of the tanning process therefore cannot be constantly improved.

Plumping also occurs at alkaline pH, in particular during liming. Usually about 3% by weight of lime in the form of CaO or slaked lime (calcium hydroxide) are added to the lime. Furthermore, from 1.5 to 2% by weight of NaSH or Na₂S are added to the lime as unhairing agents. It is observed that only a certain percentage of the lime dissolves and the remainder remains behind as undissolved sediment but is important for the process. The large amount of lime is said to be responsible for considerable environmental problems. The calcium salt load in the wastewater therefore has to be reduced by expensive measures. Attempts to replace the calcium with sodium in the form of sodium hydroxide or sodium carbonate are reported by P. Thanikaivelan et al., in JALCA 2001, 96, 222. However, the results were unsatisfactory.

Thus, leathers which were produced using sodium carbonate or sodium bicarbonate were not soft enough for commercial purposes (page 225). Also with sodium hydroxide, leathers having unsatisfactory processing properties were generally produced.

J. H. Bowes et al., J. Biochem. (1950), 46, 1-8 and 524-9, report the plumping of collagen in alkaline solution. Particularly in alkaline solution having a pH of less than 11.5, pronounced plumping of the collagen is observed.

DE 29 42 964 discloses that the amount of lime during liming can be reduced by up to 50% (page 4, line 14) if polyacrylic acid having a K value of from 10 to 150, determined according to Fikentscher is added. Smoother pelts and leathers having less lime blast are obtained (examples 5 and 6).

DE 29 42 858 discloses that the formation of abrasion areas can be reduced by adding polyacrylic acid having K values over 150, determined according to Fikentscher. However, polyacrylic acid having such high molecular weights are difficult to handle because solutions containing only 1% by weight of the high molecular weight polyacrylic acid have such high viscosities that the solution cannot be applied.

DE 19 30 225 discloses that a copolymer of 155 parts of acrylic acid and 31.5 parts of dimethylaminoethyl methacrylate quarternized with dimethyl sulfate can be used as an additive for a conventional pickle containing 5% by weight, based on the pelt weight, of sodium chloride (example b) for pickling.

FR 14 15 763 discloses a process for pickling sheep pelts, in which polyacrylic acid is added to a traditional pickle containing 5% by weight, based on the pelts, of sodium chloride.

It is an object of the present invention to provide a process for the production of leather, which avoids the abovementioned disadvantages of the prior art. In particular, it is an object of the present invention to provide a process by means of which more easily reusable wastes during splitting can be obtained.

We have found that this object is achieved by using organic polyelectrolytes in the production of semifinished products and intermediates in the production of leather. The present invention therefore relates to a process for the production of semifinished products and intermediates in the production of leather using one or more organic polyelectrolytes, comprising at least one of the following steps:
(a) Addition of one or more polyelectrolytes and from 0 to 0.7% by weight, based on the salted weight, of lime immediately before or during the liming,
(b) addition of one or more polyelectrolytes before or during deliming,
(c) addition of one or more polyelectrolytes before or during the bating,
(d) addition of one or more polyelectrolytes and a total of from 0 to 3% by weight, based on the pelt weight, of alkali metal or alkaline earth metal salt immediately before or in the pickle.

Semifinished products and intermediates in leather production or in the production of skins are understood as meaning those semifinished products and intermediates which the skins become after the various stages in the production of leather before the actual tanning, and which are known to a person skilled in the art as, for example, pelts and pickled pelts.

Organic polyelectrolytes are generally understood as meaning organic polymers having a large number of groups which are capable of dissociating into ions and which may be an integral part of the polymer chains or may be attached to these as side groups. In general, each of the random repeating units carries at least one group which is capable of dissociating into ions in aqueous solution. In the present invention, the organic polyelectrolytes also include ionomers, i.e. those organic polymers in which many, but not all, repeating units carry a group which is capable of dissociating into ions. Polymers having only one or two ionizable groups at the respective chain ends or, in the case of branched polymers, a number of dissociatable groups corresponding to the number of chain ends, are not included among polyelectrolytes in the context of the present invention.

In the novel process, polybases, polyacids, polyampholytes or their polysalts or mixtures thereof may be used. Polyacids are to be understood as meaning those organic polyelectrolytes which dissociate in an aqueous medium with elimination of protons, for example polyvinylsulfonic acid, polyvinylsulfuric acid, polyvinylphosphonic acid, polymethacrylic acid or polyacrylic acid or copolymers. Polybases are to be understood as meaning those organic polyelectrolytes which contain groups or radicals which can be protonated by reaction with Brönsted acids, for example polyethyleneimines, polyvinylamines or polyvinylpyridines. Polyampholytes are usually understood as meaning those polymers which contain both repeating units which dissociate in an aqueous medium with elimination of protons and repeating units which can be protonated by reaction with Brønsted acids. Polysalts are usually understood as meaning singly or in particular multiply deprotonated polyacids.

Synthetic polyelectrolytes are preferably used in the novel process.

The organic polyelectrolytes used in the novel process are known as such and preferably contain at least 3 identical or different repeating units of the formulae I to IV

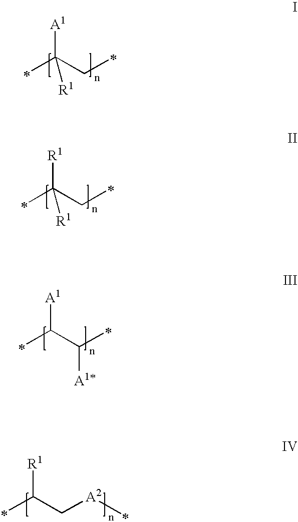

Polyelectrolytes in the context of the present invention are also to be understood as meaning those polymers which have repeating units I to IV and are not linear but branched, crosslinked, hyperbranched or dendrimeric and in which the repeating units A¹, A² and/or A¹* are not exclusively in the terminal position.

Other organic polyelectrolytes which may be used in the novel process have at least 3 repeating units of the formulae V a or V b:

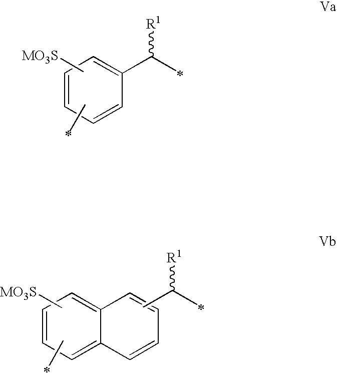

The variables are defined as follows:
n is an integer from 3 to 50 000, preferably from 20 to 10 000, particularly preferably up to 5 000.
A¹,A¹* are ionic or ionizable groups of the formulae VI to XIII 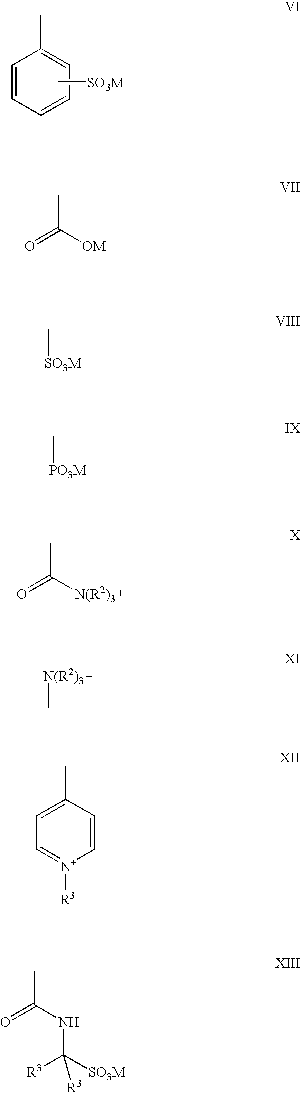
   where the variables are defined as follows:
R¹ in each case are identical or different and are selected from
   hydrogen, OH, CN,
C₁-C₂₀-alkyl, selected from methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, n-nonyl, n-decyl, n-dodecyl, n-hexadecyl and n-eicosyl; preferably C₁-C₆-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, and sec-hexyl, particularly preferably C₁-C₄-alkyl, such as methyl, ethyl, n-propyl, isopropyl, n-butyl, isobutyl, sec-butyl and tert-butyl;
C₂-C₂₀-hydroxyalkyl, for example 2-hydroxy-n-propyl, preferably ω-C₂-C₂₀-hydroxyalkyl, for example 2-hydroxyethyl, 2-hydroxy-n-propyl, 3-hydroxypropyl, 4-hydroxy-n-butyl, 6-hydroxy-n-hexyl, ω-hydroxydecyl, ω-hydroxy-n-dodecyl, ω-hydroxy-n-hexadecyl or ω-hydroxyeicosyl;
C₆-C₁₄-aryl, for example phenyl, α-naphthyl, β-naphthyl or 9-anthracenyl, in particular phenyl,
   C₁-C₆-alkoxy, such as methoxy, ethoxy, n-propoxy, isopropoxy, n-butoxy, isobutoxy, sec-butoxy, tert-butoxy, n-pentyloxy, isopentyloxy, n-hexyloxy and isohexyloxy, particularly preferably methoxy, ethoxy, n-propoxy and n-butoxy;
carboxylic esters, for example COOCH₃, COOC₂H₅, COO-n-C₃H₇, COO-iso-C₃H₇, COO-n-C₄H₉, COO-iso-C₄H₉, COO-tert-C₄H₉, COO—CH₂CH(C₂H₅)(C₄H₉), COO—CH₂CH₂OH, COO—CH₂—CH₂—CH₂—OH, COO—(CH₂)₄—OH, COO—(CH₂)₆—OH, COO(CH₂—CH₂-O)ᵣ—H, COO(CHCH₃—CH₂-O)ᵣ—H; where
r is an integer from 1 to 100, preferably from 2 to 50;
carboxamides CO—NR³R⁴ or CO—NR³R⁴CH₃+ or CO—NR³R⁴C₂H₅+,
groups of the formula CO—X¹—(CH₂)ₘ—NR³R⁴ or CO—X¹—(CH₂)ₘ—NR³R⁴CH₃+ or CO—X¹-(CH₂)ₘ—NR³R⁴C₂H₅+,
where
m is an integer from 0 to 4, preferably 2 or 3,
X¹ is oxygen or N—H,
and any positive charge or positive charges present is or are saturated by opposite ions, for example Cl⁻ or CH₃SO₄⁻.

R² is selected from hydrogen,
C₁-C₂₀-alkyl, selected from methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, n-nonyl, n-decyl, n-dodecyl, n-hexadecyl and n-eicosyl; preferably C₁-C₆-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl and sec-hexyl, particularly preferably C₁-C₄-alkyl, such as methyl, ethyl, n-propyl, isopropyl, n-butyl, isobutyl, sec-butyl and tert-butyl;
   C₃-C₁₂-cycloalkyl, such as cyclopropyl, cyclobutyl, cyclopentyl, cyclohexyl, cycloheptyl, cyclooctyl, cyclononyl, cyclodecyl, cycloundecyl and cyclododecyl; preferably cyclopentyl, cyclohexyl and cycloheptyl;
   C₇-C₁₃-aralkyl, preferably C₇- to C₁₂-phenylalkyl, such as benzyl, 1-phenethyl, 2-phenethyl, 1-phenylpropyl, 2-phenylpropyl, 3-phenylpropyl, neophyl (1-methyl-1-phenylethyl), 1-phenylbutyl, 2-phenylbutyl, 3-phenylbutyl and 4-phenylbutyl, particularly preferably benzyl;
   C₆-C₁₄-aryl, for example phenyl, 1-naphthyl, 2-naphthyl, 1-anthryl, 2-anthryl, 9-anthryl, 1-phenanthryl, 2-phenanthryl, 3-phenanthryl, 4-phenanthryl and 9-phenanthryl, preferably phenyl, 1-naphthyl and 2-naphthyl, particularly preferably phenyl;
   C₂-C₂₀-hydroxyalkyl, for example 2-hydroxy-n-propyl, preferably ω-C₂-C₂₀-hydroxyalkyl, for example 2-hydroxyethyl, 2-hydroxy-n-propyl, 3-hydroxypropyl, 4-hydroxy-n-butyl, 6-hydroxy-n-hexyl, ω-hydroxydecyl, ω-hydroxy-n-dodecyl, ω-hydroxy-n-hexadecyl or ω-hydroxyeicosyl, very particularly preferably 2-hydroxyethyl.

R³ and R⁴ are identical or different and are selected from hydrogen and C₁-C₄-alkyl, such as methyl, ethyl, n-propyl, isopropyl, n-butyl, isobutyl, sec-butyl and tert-butyl.

A² are ionic or ionizable groups, preferably selected from
—N(R²)—, —CO—N(R²)—, —N⁺(R²)₂—, —CO—N⁺(R²)₂—, where R² is as defined above.

Anions, for example halide, preferably chloride or bromide, and furthermore sulfates, hydrogen sulfate, phosphate, silicate, hydrogen phosphate and/or dihydrogen phosphate, are used for saturating positive charges in the novel process.

In on average at least one repeating unit per molecule, R² is not hydrogen, i.e. at least one nitrogen atom is exhaustively alkylated, arylated or aralkylated.

M is selected from
hydrogen,
alkali metal ions, for example Li⁺, Na⁺, K⁺, Rb⁺ or Cs⁺ or mixtures thereof, preferably Na⁺ or K⁺,
ammonium ions of the formula N(R⁵)₄⁺, where the radicals R⁵ are identical or different and are selected from
   C₁-C₂₀-alkyl, selected from methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, n-nonyl, n-decyl, n-dodecyl, n-hexadecyl and n-eicosyl; preferably C₁-C₆-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, particularly preferably C₁-C₄-alkyl, such as methyl, ethyl, n-propyl, isopropyl, n-butyl, isobutyl, sec-butyl and tert-butyl;
   C₃-C₁₂-cycloalkyl, such as cyclopropyl, cyclobutyl, cyclopentyl, cyclohexyl, cycloheptyl, cyclooctyl, cyclononyl, cyclodecyl, cycloundecyl and cyclododecyl; preferably cyclopentyl, cyclohexyl and cycloheptyl;
   C₇-C₁₃-aralkyl, preferably C₇- to C₁₂-phenylalkyl, such as benzyl, 1-phenethyl, 2-phenethyl, 1-phenylpropyl, 2-phenylpropyl, 3-phenylpropyl, neophyl (1-methyl-1-phenylethyl), 1-phenylbutyl, 2-phenylbutyl, 3-phenylbutyl and 4-phenylbutyl, particularly preferably benzyl;
   C₆-C₁₄-aryl, for example phenyl, 1-naphthyl, 2-naphthyl, 1-anthryl, 2-anthryl, 9-anthryl, 1-phenanthryl, 2-phenanthryl, 3-phenanthryl, 4-phenanthryl and 9-phenanthryl, preferably phenyl, 1-naphthyl and 2-Naphthyl, particularly preferably phenyl;
   C₂-C₂₀-hydroxyalkyl, for example 2-hydroxy-n-propyl, preferably ω-C₂-C₂₀-hydroxyalkyl, for example 2-hydroxyethyl, 2-hydroxy-n-propyl, 3-hydroxypropyl, 4-hydroxy-n-butyl, 6-hydroxy-n-hexyl, ω-hydroxydecyl, ω-hydroxy-n-dodecyl, ω-hydroxy-n-hexadecyl or ω-hydroxyeicosyl, very particularly preferably 2-hydroxyethyl,
   and in particular hydrogen.

Mixtures of the abovementioned ions may also be chosen.

In a preferred embodiment, repeating units III of the polyelectrolytes used according to the invention are formed in such a way that A¹ is COOH and A¹* is COO(CH₂—CH₂-O)ᵣ—H.

Preferably, at least 15 mol % of the repeating units A¹ in formula I or III are selected from COOH— or COOM groups, and M is as defined above.

In each case two of the radicals A¹ and A¹* may be linked to one another to form a divalent ring system having 1 to 20 ring members, for example in the manner of the following formula XIV (three ring members):

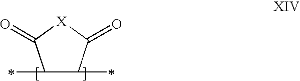

In formula XIV, X is a divalent group, for example CH₂, O or NH, N—C₁-C₂₀-alkyl or N⁻, where the negative charge is saturated with the abovementioned cations and the alkyl radicals are as defined above.

The polyelectrolytes used according to the invention preferably contain carboxyl groups, it being possible for the carboxyl groups to be present as free acids or to be present completely or in a certain percentage as salt, i.e. in neutralized form. It is preferable if a certain percentage of the carboxyl groups are neutralized. For example, from 20 to 99, particularly preferably from 50 to 95, mol % of neutralized carboxyl groups are suitable.

Very particularly preferably used polyelectrolytes are those high molecular weight compounds which are prepared from at least 60 mol % of the monomers acrylic acid, methacrylic acid and maleic acid or mixtures thereof or the relevant salts. These include in particular polyacrylates or polyacrylic acid maleic anhydride copolymers having a molar fraction of from 1 to 40%, especially from 1 to 15%, of maleic anhydride.

In order to obtain the polyelectrolytes used according to the invention and known per se, polymers or copolymers which are composed of one or more known olefinically unsaturated monomers are synthesized by known processes. Preferred monomers which, in the polymerization, give the polyelectrolytes used according to the invention are olefinically unsaturated monobasic or polybasic carboxylic acids. Acrylic acid, methacrylic acid, crotonic acid, fumaric acid and maleic acid are particularly preferred, and acrylic acid, methacrylic acid and maleic acid are very particularly preferred. Acrylic acid, methacrylic acid and maleic acid can also readily be used in the form of the anhydride in the polymerization. All monomers can be used in the polymerization as free acids, as a salt in neutralized form corresponding to the above definition and as a mixture of free acid and salt. The polyelectrolytes are synthesized by processes known per se. The polymerization is preferably effected by a free radical method, as described, for example, in DE-A 31 38 574.

Comonomers can also be used in the polymerization. Examples of suitable comonomers are
vinyl ethers, for example methyl vinyl ether, ethyl vinyl ether, vinyl-n-propyl ether, vinyl isopropyl ether, n-butyl vinyl ether, vinyl isobutyl ether, vinyl tert-butyl ether,
(meth)acrylic acid derivatives, for example methyl acrylate, methyl methacrylate, ethyl acrylate, ethyl methacrylate, acrylamide, methacrylamide, tert-butylacrylamide, tert-butyl acrylate, tert-butyl methacrylate, acrylonitrile,
olefins, for example ethylene, propylene, 1-butene, 1-pentene, 1-hexene, 1-octene, 1-decene, 1,3-butadiene, isobutene, isoprene, vinyl chloride, vinylidene chloride;
vinylaromatics, for example styrene, α-methylstyrene,
maleimide, N-methylmaleimide.

Mixtures of the abovementioned comonomers are furthermore suitable.

In order to obtain the polyelectrolytes known per se, used in the novel process and having repeating units Va and/or Vb, usually benzenesulfonic acid or naphthalenesulfonic acid is condensed ith one or more aldehydes of the formula R¹—CHO at, for example, from 80 to 120° C. and, for example, from 1 to 20 atmospheres.

The use of polyelectrolytes which contain monomers having hydrolyzable units is considered to be according to the invention also when the hydrolyzed units are completely or partly hydrolyzed.

The polyelectrolytes used according to the invention have a number average molecular weight of from 500 to 150 000 g, preferably from 1 000 to 70 000 g, particularly preferably up to 10 000 g. The width of the molecular weight distribution M_{w}/Mₙ is from 1.2 to 50, preferably from 1.5 to 15, particularly preferably from 2 to 15.

The polyelectrolytes used according to the invention preferably carry on average at least 3 repeating units I to Iv per molecule, it being possible for these groups or repeating units to be identical or different. The polyelectrolytes used according to the invention carry on average at least 4, particularly preferably 5, groups of the formula I to IV.

The polyelectrolytes described above can be used at various stages in processes for the production of semifinished products and intermediates in leather production or in the production of skins.

The polyelectrolytes described above are preferably used in the lime, before or in the deliming, before or in the bating or before or in the pickle.

A particular aspect of the present invention is the use of the organic polyelectrolytes described above in the lime, and a further aspect of the present invention is a process for the treatment of hides by using the polyelectrolytes described above in the lime.

Below, data in % by weight relate to the soaked hide, unless stated otherwise.

In order to use the organic polyelectrolytes described above in the lime, expediently the amount of lime is substantially reduced and instead an inorganic basic alkali metal compound, for example a hydroxide or carbonate of an alkali metal, preferably of sodium or potassium, very particularly preferably of sodium, and one or more of the polyelectrolytes described above are added. Other suitable inorganic basic alkali metal compounds are alkali metal silicates.

A preferred variant of the novel process comprises reducing the amount of lime used during liming to 0.1 to 0.7, particularly preferably 0.01 to 0.5, % by weight. In another particularly preferred variant, the use of lime is completely dispensed with.

According to the invention, from 0.001 to 100, preferably from 0.005 to 50, % by weight of one or more polyelectrolytes are added. From 0.03 to 10% by weight are particularly preferred and from 0.1 to 5% by weight are very particularly preferred.

The polyelectrolyte or polyelectrolytes can be added individually or together with the inorganic basic alkali metal compound or compounds. Furthermore, the addition of one or more polyelectrolytes and of the inorganic basic alkali metal compound or compounds can be effected in each case in one portion or in a plurality of portions and in each case before or during the liming. The addition directly at the beginning of liming is preferred. For example, adding a portion of polyelectrolyte immediately beforehand to the lime or during or at the end of the soaking and a further portion—together with the inorganic basic alkali metal compound or compounds—during the liming is also according to the invention. If it is desired to carry out the addition of the polyelectrolyte or polyelectrolytes in a plurality of portions, the ratio of polyelectrolyte in the individual portions is not critical. It has proven expedient to choose roughly equal portions. Another possible variant is to add from 1.1 to 10 times as much polyelectrolytes in the first portion as in the second one; another possible variant is to add from 1.1 to 10 times as much polyelectrolyte in the second portion as in the first one. Analogously, the amount of the inorganic basic alkali metal compound or compounds to be added can be divided into a plurality of portions.

In a further variant of the novel process, the polyelectrolytes can be modified in situ; for example polyacrylates or polymethacrylates can be used in the form of polymeric acids and can be converted into the polyalkali metal salt of the relevant polyelectrolyte by the basic alkali metal compound used.

According to the invention, the polyelectrolyte or polyelectrolytes can be added as such or in solution, preferably in aqueous solution. In a preferred variant of the novel process, one or more amine compounds, in particular one or more hydroxylamine compounds or hydrazine compounds, are added in the lime, in addition to the organic electrolytes described above.

Hydroxylamine compounds are of the formula XV a or b 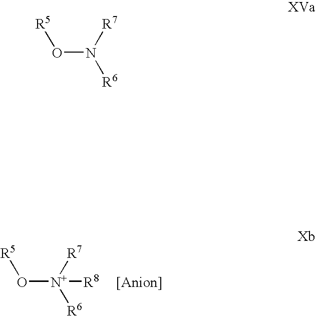
where the variables are defined as follows:
R⁵ to R⁸ are identical or different and are selected from
hydrogen,
C₁-C₂₀-alkyl,
C₆-C₁₄-aryl,
alkyl and aryl radicals being as defined above.

Preferably, at least one of the radicals R⁵ to R⁸ in formula XV a or XV b is hydrogen.

Examples of anions are halide, preferably chloride or bromide, and furthermore sulfate, hydrogen sulfate, phosphate, hydrogen phosphate and/or dihydrogen phosphate.

The use of hydroxylamine compounds of the formula XV a is preferred. The use of hydroxylamine as free base is very particularly preferred.

Hydrazine compounds are of the formula XVI 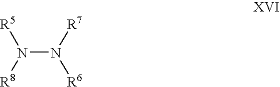
where R⁵ to R⁸ are as defined above and can be protonated.

If one or more hydroxylamine compounds of the formula XV a are used, the amount of basic alkali metal compounds can be reduced.

It is particularly advantageous to use one or more hydroxylamine compounds of the formula XV a or XV b or one or more hydrazine compounds of the formula XIV, together with alkali metal hydroxide and alkali metal carbonate, in the lime, in addition to the polyelectrolyte.

The amount of hydroxylamine compounds of the formula XV a or XV b or one or more hydrazine compounds of the formula XIV which is preferably used in the lime is from 0.5 to 10% by weight.

Of course, conventional tanning assistants may also be added to the solution of the polyelectrolyte, for example biocides, enzymes, unhairing agents, surfactants and emulsifiers.

A further aspect of the present invention is the addition of one or more of the polyelectrolytes described above before or during the deliming. According to the invention, from 0.001 to 100, preferably from 0.005 to 50, % by weight of one or more polyelectrolytes are added. From 0.03 to 10% by weight are particularly preferred and from 0.1 to 5% by weight are very particularly preferred.

A further aspect of the present invention is the addition of one or more of polyelectrolytes described above before or during the bating. According to the invention, from 0.001 to 100, preferably from 0.05 to 50, % by weight of one or more polyelectrolytes are added. From 0.03 to 10% by weight are particularly preferred and from 0.1 to 5% by weight are very particularly preferred.

A further particular aspect of the present invention is the use of the polyelectrolytes described above before or in the pickle, preferably immediately before the pickle, and a further aspect of the present invention is a process for the treatment of hides by using the polyelectrolytes described above before or in the pickle.

Below, the data in % by weight are based on the pelt weight, unless stated otherwise.

In an expedient procedure for using the polyelectrolytes described above before or in the pickle, the amount (usually from 5 to 10% by weight) of alkali metal halide used, usually sodium chloride, can be reduced and instead a novel amount of one or more polyelectrolytes can be used.

According to the invention, from 0.001 to 100, preferably from 0.005 to 50, % by weight of one or more polyelectrolytes are used. From 0.03 to 10% by weight are particularly preferred and from 0.1 to 5% by weight are very particularly preferred.

According to the invention, from 0 to 3, preferably from 0 to 1, particularly preferably from 0 to 0.5, % by weight of one or more inorganic alkali metal or alkaline earth metal salts, for example alkali metal halides, such as sodium fluoride, sodium chloride, sodium bromide, potassium chloride or potassium bromide or mixtures thereof, are furthermore used according to the invention before or in the pickle, preferably in each case before the pickle. It is also possible to use other inorganic alkali metal salts, for example Glauber's salt (sodium sulfate), or inorganic alkaline earth metal salts, for example magnesium chloride or magnesium sulfate. In a very particularly preferred variant, at least from 0.01 to 0.2% by weight of inorganic alkali metal or alkaline earth metal salts, in particular sodium chloride, is used; in another very particularly preferred variant, the use of alkali metal or alkaline earth metal salts is completely dispensed with. Very particularly preferably, in particular not more than 0.05% by weight of alkali metal halide, in particular sodium chloride, is used.

The addition of one or more polyelectrolytes and alkali metal or alkaline earth metal salts, where addition of alkali metal or alkaline earth metal salts is desired, can be effected separately or together and in each case immediately before or during the pickle. Furthermore, the addition of one or more polyelectrolytes and—where desired—alkali metal and alkaline earth metal salts can be effected in each case in one portion or in a plurality of portions and in each case before or during the pickle. For example, the addition of a portion of polyelectrolyte immediately before the pickle and a further portion—together with alkali metal or alkaline earth metal salt—during the pickle is also according to the invention. If it is desired to carry out the addition of the polyelectrolyte or polyelectrolytes in a plurality of portions, the ratio of polyelectrolyte in the individual portions is not critical. It has proven expedient to choose approximately equal portions. Another possible variant is to add from 1.1 to 10 times as much polyelectrolyte in the first portion as in the second one; another possible variant is to add from 1.1 to 10 times as much polyelectrolyte in the second portion as in the first one. Analogously, the amount of the alkali metal or alkaline earth metal salt or salts to be added can be distributed over a plurality of portions.

According to the invention, the polyelectrolyte or polyelectrolytes can be added as such or in solution, preferably in aqueous solution, it also being possible for assistants customary in tanning to be added to the solution, for example biocides, acids, such as sulfuric acid, formic acid, hydrochloric acid, oxalic acid or acetic acid, acidic salts, buffers, fatliquoring agents, resin tanning agents, vegetable tanning agents and fillers, for example kaolin or ligninsulfonate.

In the novel process, the residence time of the hides in the pickle is usually from 10 minutes to 24 hours, preferably from 15 minutes to 2 hours, particularly preferably from 15 to 45 minutes. Pickling takes place under conditions otherwise customary in tanning, the temperature being from 10 to 35° C. and the pressure from 1 to 10 bar, particularly expediently atmospheric pressure.

If, according to the invention, one or more polyelectrolytes are used before or during liming, the amount of polyelectrolyte added in the pickle can be reduced. In the extreme case, the further addition of more polyelectrolytes in or immediately before the pickle can be completely dispensed with.

In a particular variant of the novel process, from 5 to 100% by weight of one or more polyelectrolytes are added during liming, and the addition of further polyelectrolytes can be dispensed with in the further steps deliming, bating and pickle, because the concentration of polyelectrolytes is sufficiently high. In a preferred variant of the novel process in which the addition of lime is completely dispensed with, a separate deliming step can be omitted; in this variant in particular it is possible to dispense with further addition of polyelectrolyte.

By means of the novel process, it is possible, in the production of leather, to obtain not only semifinished products and intermediates which have improved properties compared with the prior art. It is also possible, according to the invention, substantially to reduce the wastewater pollution. Not only a reduction in the sludge load, which consists of lime itself and organic and inorganic byproducts separated by lime and obtained in the production of semifinished products or intermediates, but also a reduced COD is observed, so that the wastewater treatment is substantially simpler and hence advantageous.

A further aspect of the present invention comprises semifinished products and intermediates which have been produced by the novel process.

The semifinished products and intermediates are subsequently further processed by methods customary in tanning, i.e. tanning is effected with the conventional agents, for example Cr(III) compounds, aldehydes, syntans or polymer tanning agents or a mixture thereof, if required after a pretanning step. Steps customary in tanning, such as dyeing, fatliquoring and retanning, are then carried out.

A further aspect of the present invention comprises leathers which are produced by tanning semifinished products and intermediates which have been produced by the novel process. They have particularly advantageous performance characteristics, in particular high tensile strength, colorability and body.

The working examples which follow illustrate the invention.

### WORKING EXAMPLES

The values in % by weight relate in each case to the salted weight, unless stated otherwise.

General working method for soaking hides:

A Southern German cattle hide was first presoaked at 28° C. in 200% by weight of water and 0.2% by weight of a Eusapon® W for 120 minutes in a drum with low speed. The liquor was discharged and the hide was then soaked with 100% by weight of water, 0.2% by weight of Eusapon® W and 0.5% by weight of sodium carbonate for 19 hours, the vessel being rotated for 5 minutes in every hour.

The liquor was then discharged.

General Working Methods:

1. Liming

80% by weight, based on the salted weight, of water were then added, as well as 1.0% by weight of Mollescal® SF from BASF Aktiengesellschaft, to a soaked Southern German cattle hide. After 30 minutes running time, 0.8% by weight of NaHS and 1% by weight of lime were added. After a further 30 minutes running time, 0.75% by weight of Na₂S was added. After a further 30 minutes running time, 1.0% by weight of lime and a further 0.75% by weight of Na₂S were added. After 20 minutes, 70% by weight of water and 1.0% by weight of lime were added and the hide was left to stand for a further 20 minutes. The liquor was discharged and the pelt was washed with water.

Thereafter, the limed soaked pelt thus obtained was split to a thickness of 2.5-2.8 mm and delimed by the following procedure:

100% by weight of water and 0.1% by weight of sodium bisulfite and 0.5% by weight of Decaltal® R from BASF Aktiengesellschaft were added to the pelt. After 20 minutes, the liquor was discharged and 50% by weight of water, 0.1% by weight of sodium bisulfite and 1.2% by weight of Decaltal®R from BASF Aktiengesellschaft and 0.3% by weight of a mixture consisting of two parts by weight of ammonium sulfate, two parts by weight of formic acid and three parts by weight of adipic acid were added. Thereafter, the liquor was discharged and the pelts thus obtained were-cut into strips of about 500 g each.

2. Pickle

Below, the data in % by weight are based on the pelt weight, unless stated otherwise.

The delimed cattle pelts prepared according to the above procedure were placed in 100% by weight of water (20-25° C.) in 15 10 l drums from Dose. The polyelectrolytes shown in the in table 1 were then metered into test drums 1 to 15. Correspondingly, for comparative examples V1 to V3, in each case 7% by weight of sodium chloride (V1) were used instead of the polyelectrolytes used according to the invention or both were dispensed with (V2) or low molecular weight Picaltal® was used (V3). Two portions of an acid mixture consisting of 50% by weight of formic acid and 50% by weight of a semiconcentrated sulfuric acid were then added to each of the test drums at intervals of 15 minutes, each individual portion corresponding to a weight equivalent of 0.6.

The time until the hide showed complete acid penetration in the cut by means of bromocresol green was noted, and the pH of the liquor was corrected, if necessary, with concentrated sulfuric acid to pH 3.0-3.2.

The analysis of the product was carried out by determining the plumping behavior or the change in skin thickness by means of a thickness gage (mean value of a triple determination) and gravimetrically by means of the amount of incorporated water (table 1).

TABLE 1
Pickling of cattle hides

| | | | | | | T | | |
|---|---|---|---|---|---|---|---|---|
| | | | | | | Acid | Δ Skin | Δ |
| | | Amount | Conc. | 10³ · Mₙ | | diff. | thickness | Weight |
| Ex. | Polyelectrolyte | [%] | [%] | [g] | M_{w}/Mₙ | [min] | [mm] | [g] |
| 1 | Polyacrylic | 1.5 | 50 | 1.2 | 2.0 | 15 | −0.2 | −8 |
| | acid | | | | | | | |
| 2 | Na | 2.0 | 40 | 1.2 | 2.0 | 10 | −0.25 | −10 |
| | polyacrylate | | | | | | | |
| 3 | Polyacrylic | 2.0 | 40 | 10 | 2.9 | 15 | −0.3 | −12 |
| | acid | | | | | | | |
| 4 | Na | 2.0 | 40 | 10 | 2.9 | 20 | −0.3 | −13 |
| | polyacrylate | | | | | | | |
| 5 | K | 2.0 | 35 | 70 | 4.8 | 20 | −0.25 | −9 |
| | polyacrylate | | | | | | | |
| 6 | Na | 1.5 | 40 | 16 | 8.6 | 15 | −0.3 | −14 |
| | polyacrylate | | | | | | | |
| 7 | Polymethacrylic | 2.0 | 40 | 18 | 3.4 | 25 | −0.15 | −8 |
| | acid | | | | | | | |
| 8 | Polyacrylate/ | 2.5 | 35 | 9 | 2.7 | 10 | −0.1 | −2 |
| | maleic | | | | | | | |
| | anhydride | | | | | | | |
| | copolymer | | | | | | | |
| | (molar ratio | | | | | | | |
| | 8:2) | | | | | | | |
| 9 | Polyacrylate/ | 2.5 | 35 | 5.4 | 4.2 | 20 | −0.15 | −4 |
| | maleic | | | | | | | |
| | anhydride/ | | | | | | | |
| | C₁₂-olefin | | | | | | | |
| | terpolymer | | | | | | | |
| | (molar ratio | | | | | | | |
| | 6:2:2) | | | | | | | |
| 10 | Polyvinyl- | 2.0 | 40 | 30 | 3.8 | 25 | −0.1 | −2 |
| | amine | | | | | | | |
| 11 | Poly | 5.0 | 20 | 80 | 6.3 | 30 | −0.12 | −6 |
| | ethylenimine | | | | | | | |
| 12 | 9/1 | 1.5 | 50 | 4 | 3.9 | 15 | −0.27 | −14 |
| | Polyacrylic | | | | | | | |
| | acid/vinyl- | | | | | | | |
| | sulfonic | | | | | | | |
| | acid | | | | | | | |
| 13 | Urea/formaldehyde/ | 2.0 | 100 | 15 | 8.4 | 15 | −0.15 | −8 |
| | phenol- | | | | | | | |
| | sulfonic | | | | | | | |
| | acid | | | | | | | |
| 14 | Starch | 2.5 | 100 | — | — | 30 | −0.1 | −0.5 |
| | (cationic) | | | | | | | |
| 15 | Lignin- | 2.5 | 100 | — | — | 25 | 0.1 | 3 |
| | sulfonate | | | | | | | |
| V1 | NaCl | 7 | 100 | | | 20 | −0.35 | −17 |
| V2 | — | — | — | | | 45 | 1.9 | 74.5 |
| V3 | Picaltal ® | 2.5 | 100 | | | 20 | −0.12 | 0.9 |
| | (Naphthyl- | | | | | | | |
| | sulfonic | | | | | | | |
| | acid) | | | | | | | |

Ligninsulfonate: from Borregaard Ind. Ltd., Sampborg, Norway, type DP 581

3. Tanning

For the detailed testing of the performance characteristics and physical properties of the leather, the pickled pelts resulting from novel examples 1 to 15 and comparative examples V1 to V3 were first converted into wet blue semifinished products in 50 l drums by the chrome tanning method described below, all percentages by weight being based on the pickled pelts, unless stated otherwise:

First, the pickled pelts were additionally tanned with, in each case, 1% by weight of sodium formate and 7% by weight of the chrome tanning agent Chromitan® FM for 4 hours at from 20 to 40° C. in the respective pickle baths described above. Thereafter, 0.35% by weight of sodium formate was added and the pelts were left to stand overnight.

Thereafter, washing was carried out with, in each case, 200% by weight of water and 0.2% by weight of formic acid (15 minutes at 40° C.) and the liquor was discharged. Retanning was then carried out with 100% by weight of water, 0.5% by weight of sodium bicarbonate and 2% by weight of sodium formate as well as 1% by weight of a tanning agent based on naphthalenesulfonic acid, commercially available as Tamol® M from BASF Aktiengesellschaft, at a pH of from 4.6 to 4.8, and the liquor was discharged after being slowly agitated for 1 hour at 35° C.

Dyeing was then carried out by a conventional method with Luganil® brown (commercially available from BASF Aktiengesellschaft) at 70° C. and fatliquoring was carried out with 4% by weight of the fatliquoring agent Lipoderm Licker® SLW and 2% by weight of the fatliquoring agent Lipoderm Licker® WF, both available from BASF Aktiengesellschaft, and 2% by weight of formic acid. The leathers thus obtained were washed with water, dried by conventional methods and set out. The physical properties and performance characteristics were then tested.

The tear propagation strength according to DIN 53329, the tensile strength according to DIN 53328 and the stitch tear resistance according to DIN 53331 were determined by physical measuring methods on the leather samples (table 2). Furthermore, the grain tightness, the body and softness of the leathers are rated according to a relative scale of 1-5.

TABLE 2
Testing of performance characteristics of the leathers
according to examples 1 to 15 and V1 to V3

| | | Tear | Stitch | | | |
|---|---|---|---|---|---|---|
| | Tensile | propagation | tear | | | |
| | strength | strength | resistance | Grain | | |
| Ex. | [N] | [N/mm] | [N] | tightness | Body | Softness |
| 1 | 338 | 49 | 216 | 2 | 2 | 3 |
| 2 | 346 | 51 | 220 | 2 | 2 | 2 |
| 3 | 352 | 48 | 214 | 2 | 3 | 2 |
| 4 | 348 | 50 | 221 | 2 | 2 | 2 |
| 5 | 334 | 48 | 218 | 3 | 3 | 2 |
| 6 | 358 | 58 | 224 | 2 | 2 | 3 |
| 7 | 341 | 54 | 218 | 3 | 3 | 3 |
| 8 | 365 | 56 | 222 | 1 | 2 | 2 |
| 9 | 334 | 51 | 216 | 3 | 2 | 2 |
| 10 | 326 | 42 | 194 | 3 | 3 | 3 |
| 11 | 318 | 40 | 183 | 2 | 3 | 3 |
| 12 | 338 | 53 | 210 | 2 | 2 | 2 |
| 13 | 310 | 41 | 206 | 3 | 2 | 2 |
| 14 | 290 | 34 | 194 | 3 | 2 | 2 |
| 15 | 297 | 40 | 202 | 3 | 2 | 2 |
| V1 | 340 | 54 | 218 | 3 | 2 | 3 |
| V2 | 170 | 26 | 184 | 4 | 4 | 3 |
| V3 | 325 | 48 | 212 | 3 | 2 | 2 |

Body and softness were rated as
1: very good,
2: good,
3: satisfactory,
4: adequate,
5: poor,
6 inadequate.

### Examples 16-25 and Comparative Examples V4-V5: Liming

The soaked Southern German cattle hides were fleshed in the green state (thickness about 4 mm) and the butts of the hides were cut into hide pieces of 2.5 kg each.

Liming of Comparative Examples V4 and V5

For comparative example V4, 100 parts by weight of hide were treated in succession with 60 parts by weight of water, 0.8% by weight of NaSH and 3% by weight of calcium hydroxide in a rotatable 10 l drum containing baffles. 0.75% by weight of sodium sulfide followed at intervals of 30 minutes. The drum was operated for a further 45 minutes at 15 revolutions per minute. A further 40 parts by weight of water were then metered. After 10 hours at from 23 to 27° C. and 5 revolutions per minute, the experiments were stopped by discharging the liquor and the hides were washed twice for 15 minutes with 150 parts by weight of water. For comparative example V5, the lime fraction was accordingly replaced with 0.9% by weight of sodium hydroxide.

1.2. Liming of Novel Example 16 to 25

For the experiments of novel examples 15 to 26, the soaked hide pieces were treated in 60% by weight of water for 30 minutes at 20-25° C. with the polyelectrolyte additive listed in table 3 (10 revolutions per minute). 0.1% by weight of concentrated sodium hydroxide solution and 0.8% by weight of NaHS were then simultaneously metered. After 15 minutes, three portions of 0.75% by weight of sodium sulfide were added at intervals of 30 minutes. After a further 15 minutes, the basic agents shown in table 3 were metered. After 10 minutes at from 23 to 27° C. and 5 revolutions per minute, the experiments were stopped by discharging the liquor and the hides were washed twice for 15 minutes with 150 parts by weight of water each time.

2. Further Processing (Deliming and Pickling) of Comparative Examples V4 and V5 and of Novel Examples 16 to 25

The deliming or neutralization was carried out using a mixture consisting of two parts by weight of ammonium sulfate, two parts by weight of formic acid and three parts by weight of adipic acid. For this purpose, the liquor was brought to a pH of 7.5-8.5 in two metering steps. The penetration of the acid mixture over the hide cross-section was checked with phenolphthalein as indicator. The time required for this purpose was noted.

The pelts obtained above were then pickled in a conventional pickling bath at 25° C. for 30 minutes with 7% by weight of sodium chloride. Thereafter, 1% by weight of Lipoderm Licker® Al and, after a further 20 minutes, 4% by weight of formic acid were added. After a further half hour, a pH was brought to 3 with concentrated sulfuric acid.

The pickled pelts were rated (table 4) taking into account the criteria of increase in hide thickness, weight change (incorporated water) and assessment of the completeness of hair decomposition. In a further step, for determining the stitch tear resistance according to DIN 53331, the hide pieces prepared above were tanned together in a 50 l drum as follows and tanned according to a formulation for the production of wet white furniture leather:

In each case 2.5% by weight of a glutaraldehyde formulation, commercially available as Relugan® GT 24 from BASF Aktiengesellschaft, were added to the pickle baths described above. After 90 minutes, 3% by weight of a synthetic tanning agent, commercially available as Basyntan® SW fl. from BASF Aktiengesellschaft, were added. After 30 minutes, 1% by weight of a tanning agent based on naphthalenesulfonic acid, commercially available as Tamol® M from BASF Aktiengesellschaft, was added and the baths were gently agitated overnight. Neutralization was then effected with sodium formate and sodium bicarbonate and the liquor was discharged.

The leathers thus obtained were washed with water, dried by a conventional method, set out and shaved. The physical properties and performance characteristics were then tested.

The shaved thickness of the leather was 2.0-2.2 mm.

TABLE 3
Use of polyelectrolytes in liming

| | | | | | | | Amount | |
|---|---|---|---|---|---|---|---|---|
| | | | | Amount | | | of acid | |
| | Polyelectrolyte | Amout | | of | Lime | | Neutralization | t |
| | analogous | [% by | Alkaline | alkaline | [% by | pH | [% by | [min] |
| Ex. | to ex. | wt.] | agent | component | wt.] | Liquor | wt.] | Neutralization |
| 16 | 2 | 1.2 | NaOH | 0.8 | 0.7 | 12.5 | 1.1 | 35 |
| 17 | 2 | 1.2 | NaOH | 0.8 | — | 12.1 | 1.0 | 40 |
| 18 | 3 | 1.5 | NaOH/ | 0.7/0.4 | — | 12.0 | 0.8 | 25 |
| | | | Hydroxylamine | | | | | |
| 19 | 7 | 2.0 | Na₂CO₃ | 1.5 | 0.7 | 11.8 | 0.7 | 40 |
| 20 | 2 | 2.5 | NaOH | 0.9 | — | 12.4 | 1.2 | 30 |
| 21 | 9 | 2.0 | NaOH | 0.5 | 0.5 | 12.2 | 1.1 | 50 |
| 22 | 10 | 1.5 | NaOH | 0.9 | — | 12.3 | 1.1 | 45 |
| 23 | 12 | 1.5 | KOH | 0.7 | — | 12.1 | 1.2 | 35 |
| 24 | 3 | 2.0 | NaOH | 0.6 | 0.3 | 12.1 | 1.4 | 40 |
| 25 | 8 | 2.0 | KOH/ | 0.5/ | — | 12.2 | 0.9 | 25 |
| | | | Hydroxylamine | 0.6 | | | | |
| 26 | Sodium | 2.5 | Sodium | — | 0.7 | 11.9 | 0.8 | 45 |
| | silicate | | silicate/ | | | | | |
| | | | NaOH | | | | | |
| V 4 | — | — | Lime | — | 3.0 | 12.2 | 1.8 | 55 |
| V 5 | — | — | NaOH | 0.9 | — | 12.2 | 1.0 | 90 |

TABLE 4
Analytical data of the wet white furniture leather,
produced from the pelts in table 3

| | | | | Stitch tear |
|---|---|---|---|---|
| | Weight | | Grain tightness | resistance according |
| | change | Hair | Wet white | to DIN 53331 |
| Ex. | [%] | decomposition | leather | [N] |
| 16 | 18 | 2 | 2 | 166 |
| 17 | 22 | 2.5 | 1 | 173 |
| 18 | 17 | 3 | 3 | 176 |
| 19 | 34 | 3 | 2 | 146 |
| 20 | 21 | 3.5 | 3 | 167 |
| 21 | 28 | 2 | 2 | 148 |
| 22 | 34 | 1.5 | 2 | 133 |
| 23 | 29 | 2 | 2 | 158 |
| 24 | 20 | 3 | 3 | 164 |
| 25 | 24 | 3.5 | 3 | 134 |
| 26 | 37 | 2 | 1.5 | 141 |
| V4 | 34 | 2 | 2 | 138 |
| V5 | 160 | 5 | 5 | 94 |

The grain tightness was rated as follows: 1 very good, 2 good, 3 satisfactory, 4 adequate, 5 poor, 6 inadequate

1. A process for the production of semifinished products and intermediates in the production of leather using one or more organic polyelectrolytes, comprising at least one of the following steps:
(a) adding one or more polyelectrolytes and from 0 to 0.7% by weight, based on the salted weight, of lime immediately before or during the liming,
(b) adding one or more polyelectrolytes before or during the bating,
(c) adding one or more polyelectrolytes and a total of from 0 to 3% by weight, based on the pelt weight, of an alkali metal or alkaline earth metal salt immediately before or in the pickle.

2. The process as claimed in claim 1, wherein the one or more organic polyelectrolytes used, are polyampholytes.

3. The process as claimed in claim 1, wherein the one or more organic polyelectrolytes used, are polyacids.

4. The process as claimed in claim 1, wherein the one or more organic polyelectrolytes used, is a polybase are polybases.

5. The process as claimed in claim 1, wherein the one or more organic polyelectrolytes used, are polysalts.

6. The process as claimed in any of the preceding claim 1, wherein one or more hydroxylamine compounds of the formula XV a or XV b 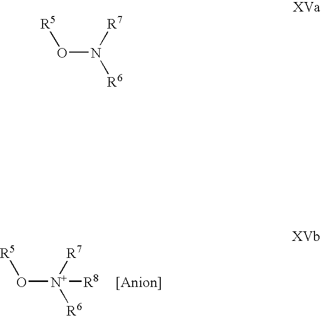
where R⁵ to R⁸ are identical or different and are selected from
hydrogen,
C₁-C₂₀-alkyl,
C₆-C₁₄-aryl,
and the anion is selected from halide, sulfate, hydrogen sulfate, phosphate, hydrogen phosphate and dihydrogen phosphate or mixtures thereof,
or one or more hydrazine compounds of the formula XVI, 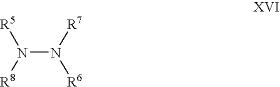
which may be protonated and in which R⁵ to R⁸ are as defined above,
are furthermore added in step (a).

7. The process as claimed in claim 6, wherein hydroxylamine is added in step (a).

8. The process as claimed in claim 6, wherein one or more hydroxylamine compounds of the formula XV a or XV b or one or more hydrazine compounds of the formula XVI are used together with alkali metal hydroxide and alkali metal carbonate in step (a).

9. A semifinished product or intermediate in the production of leather, produced by the process as claimed in claim 1.

10. A process for producing leather, comprising subjecting the semifinished product or intermediate of claim 9 to a tanning process.

11. The process as claimed in claim 2, wherein one or more hydroxylamine compounds of the formula XV a or XV b 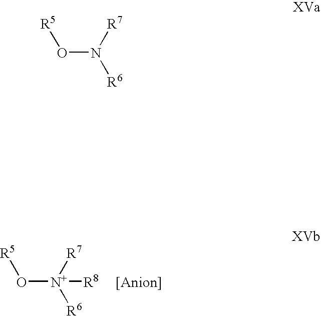
where R⁵ to R⁸ are identical or different and are selected from
hydrogen,
C₁-C₂₀-alkyl,
C₆-C₁₄-aryl,
and the anion is selected from halide, sulfate, hydrogen sulfate, phosphate, hydrogen phosphate and dihydrogen phosphate or mixtures thereof,
or one or more hydrazine compounds of the formula XVI, 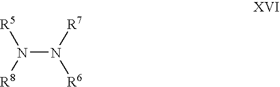
which may be protonated and in which R⁵ to R⁸ are as defined above,
are furthermore added in step (a).

12. The process as claimed in claim 3, wherein one or more hydroxylamine compounds of the formula XV a or XV b 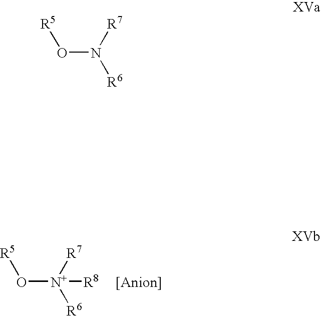
where R⁵ to R⁸ are identical or different and are selected from
hydrogen,
C₁-C₂₀-alkyl,
C₆-C₁₄-aryl,
and the anion is selected from halide, sulfate, hydrogen sulfate, phosphate, hydrogen phosphate and dihydrogen phosphate or mixtures thereof,
or one or more hydrazine compounds of the formula XVI, 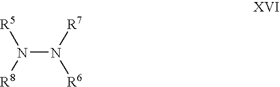
which may be protonated and in which R⁵ to R⁸ are as defined above,
are furthermore added in step (a).

13. The process as claimed in claim 4, wherein one or more hydroxylamine compounds of the formula XV a or XV b 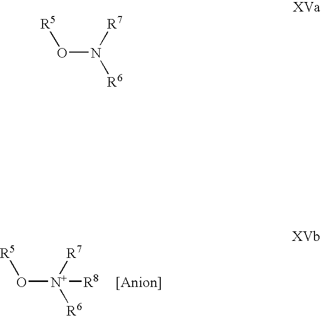
where R⁵ to R⁸ are identical or different and are selected from
hydrogen,
C₁-C₂₀-alkyl,
C₆-C₁₄-aryl,
and the anion is selected from halide, sulfate, hydrogen sulfate, phosphate, hydrogen phosphate and dihydrogen phosphate or mixtures thereof,
or one or more hydrazine compounds of the formula XVI, 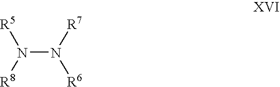
which may be protonated and in which R⁵ to R⁸ are as defined above,
are furthermore added in step (a).

14. The process as claimed in claim 5, wherein one or more hydroxylamine compounds of the formula XV a or XV b 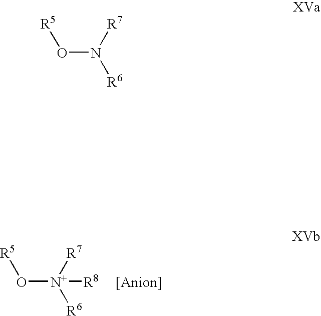
where R⁵ to R⁸ are identical or different and are selected from
hydrogen,
C₁-C₂₀-alkyl,
C₆-C₁₄-aryl,
and the anion is selected from halide, sulfate, hydrogen sulfate, phosphate, hydrogen phosphate and dihydrogen phosphate or mixtures thereof,
or one or more hydrazine compounds of the formula XV¹, 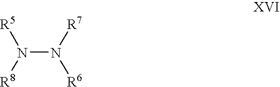
which may be protonated and in which R⁵ to R⁸ are as defined above,
are furthermore added in step (a).

15. The process as claimed in claim 11, wherein hydroxylamine is added in step (a).

16. The process as claimed in claim 12, wherein hydroxylamine is added in step (a).

17. The process as claimed in claim 13, wherein hydroxylamine is added in step (a).

18. The process as claimed in claim 14, wherein hydroxylamine is added in step (a).

19. The process as claimed in claim 11, wherein one or more hydroxylamine compounds of the formula XV a or XV b or one or more hydrazine compounds of the formula XVI are used together with alkali metal hydroxide and alkali metal carbonate in step (a).

20. The process as claimed in claim 12, wherein one or more hydroxylamine compounds of the formula XV a or XV b or one or more hydrazine compounds of the formula XVI are used together with alkali metal hydroxide and alkali metal carbonate in step (a).
